(19) United States
(12) Patent Application Publication
(10) Pub. No.: US 2025/0163621 A1
(43) Pub. Date: May 22, 2025

(54) BIODEGRADABLE AND HYDROPHOBIC POLYLACTIC ACID (PLA ) NON-WOVEN MATERIAL AND PROCESS FOR MANUFACTURING THEREOF

(71) Applicant: Nano and Advanced Materials Institute Limited, Hong Kong (HK)

(72) Inventors: Yuyan SONG, Hong Kong (HK); Sik Chun Johnny LO, Hong Kong (HK); Yeuk Tin LAU, Hong Kong (HK); Sui Han SIN, Hong Kong (HK)

(21) Appl. No.: 18/954,547

(22) Filed: Nov. 21, 2024

Related U.S. Application Data
(60) Provisional application No. 63/601,713, filed on Nov. 21, 2023.

(51) Int. Cl. D04H 1/4374; B01D 39/16; B01D 61/02; B01D 71/48; D01D 5/00; D01F 1/10; D01F 6/62; D04H 1/435; D04H 1/4382; D04H 1/728

(52) U.S. Cl. CPC D04H 1/4374; B01D 39/163; B01D 61/027; B01D 71/48; D01D 5/0038; D01F 1/10; D01F 6/625; D04H 1/435; D04H 1/43838; D04H 1/728; B01D 2239/025; B01D 2239/0266; B01D 2239/0428; B01D 2239/0618; B01D 2239/0627; B01D 2239/0631; B01D 2239/065; B01D 2239/10; B01D 2239/1233; B01D 2239/1291; D10B 2331/041; D10B 2401/021; D10B 2401/12; D10B 2505/04; D10B 2509/00

(57) ABSTRACT

The present invention relates of a biodegradable and hydrophobic polylactic acid (PLA) non-woven material and a process for manufacturing thereof, said PLA non-woven material comprising a non-woven fabric for personal protective equipment, and a non-woven fabric for the three layer surgical mask; said PLA non-woven material comprising a layer of nanofiber membrane and a layer of biodegradable spunbond fabric which could fulfil the international biodegradation standard EN13432. Said non-woven fabric for the PPE has at least 45N breaking force, at least 15% elongation, and having passed level 3 fluid resistance test according to AATCC 42 and AATCC 127.

### TECHNICAL FIELD

The present invention relates of a biodegradable and hydrophobic polylactic acid (PLA) non-woven material and a process for manufacturing thereof, more particularly, hydrophobic polylactic acid (PLA) non-woven material with sub-micron airborne filtration capabilities and fluid resistance, while maintaining acceptable breathability.

### BACKGROUND

Polylactic acid (PLA) is a biodegradable, bio-based polymer derived from renewable resources like corn starch or sugarcane. PLA-based nonwoven materials are gaining popularity due to their biodegradability and potential for reducing plastic waste in various applications, including disposable products. PLA is non-toxic and safe for skin contact, making it suitable for medical and personal protective equipment.

PLA nonwoven materials are lightweight, breathable, and compostable. These materials degrade into carbon dioxide and water under industrial composting conditions. PLA nonwovens are produced through processes like melt-blowing or solution-based processes depending on the required end-use. Conventionally, these processes create fiber diameters larger than 1 μm, and cannot achieve ultra-fine diameters. It is even more difficult to achieve an ultra-fine diameter after addition of functional hydrophobic additives. Such additives are used when the final nonwoven material is to be used for personal protective equipment such as masks, since such materials should typically be hydrophobic in order to repel bodily fluids.

During melt-blowing, PLA resin is melted and extruded through a series of fine nozzles to create fibers. The fibers are then blown with hot air and deposited onto a conveyor belt to form a nonwoven fabric. The melt-blowing process requires a very high melt flow rate, for example, up to 1,500 g/10 min. However, biodegradable polymers like PLA, commonly have low melt flow rates, around 15 g/10 min for melt-blowing. Moreover, the diameter of fibers produced by melt-blowing is relatively large (>1 μm), leading to larger pore size and thereby low filtration efficiency in a nonwoven material. Consequently, additional treatments, such as fiber charging, are required to improve the filtration efficiency by electrostatic deposition.

Alternatively, biodegradable PLA non-woven can be fabricated by solution methods instead of melt processes. Electrospinning (ES) is a commercially available method using an electric field to draw a polymer solution of PLA in into ultrafine fibers. PLA is dissolved in a solvent such as chloroform or dichloromethane, to create a solution of a desired viscosity. A high voltage is applied between the tip of a fine nozzle/needle and a grounded collector, creating an electric field that overcomes the surface tension of the polymer solution, pulling it into a thin jet. As solvent evaporates from the thin jet, PLA fibers are collected to form a non-woven mat.

At the tip of the needle, the electric field induces a “Taylor cone” where the solution starts to stretch into a jet. As the jet travels through the air, the solvent evaporates, leaving behind solidified PLA fibers. The solidified PLA fibers are collected on a grounded collector, which can be a flat surface (to create a uniform mat) or a rotating drum (for aligned fibers). As the fibers accumulate, they form a nonwoven fabric or mesh with nanoscale to microscale pores.

However, conventional PLA polymers are typically stereochemically pure L-isomer which has limited solubility in common electrospinning organic solvents due to the semi-crystalline and tightly packed structure. As a result, PLA is typically soluble only in solvents with low boiling points such as chloroform and dichloromethane. These solvents are incompatible with natural/biodegradable hydrophobic additives such as insect waxes, which are highly viscous materials. Electrospinning solutions with such hydrophobic additives have high viscosity and poor spinnability; this leads to bead defect formation and large diameter fibers (>1 μm). Such fibers have low filtration efficiency due to large pore sizes.

Thus, there is a need in the art for new biodegradable and hydrophobic polylactic acid (PLA)-based non-woven materials and processes for manufacturing these materials. Such materials could be used to provide hydrophobic filtration materials that are both breathable and fluid resistant.

### SUMMARY OF THE INVENTION

The present invention provides biodegradable nonwoven replacement materials comprising a non-woven fabric for personal protective equipment, and a non-woven fabric for a three layer surgical mask.

In one aspect of the biodegradable nonwoven replacement materials of the present invention, wherein the non-woven fabric for personal protective equipment having at least 45N breaking force, at least 15% elongation, and having passed level 3 fluid resistance test according to AATCC 42 and AATCC 127.

In another of the biodegradable nonwoven replacement materials of the present invention, wherein the three layer surgical mask having no more than 5 mmH2O/cm2 differential pressure, at least 95% filtration efficiency for particles ranged from 2.7 micron to 3.3 micron under 0.27 m/s face velocity and having passed the fluid resistance test according to ASTM F2100 level 1.

In one aspect of the biodegradable nonwoven materials of the present invention, the biodegradable nonwoven replacement materials may include a layer of nanofiber nonwoven membrane bonded to a layer of biodegradable spunbond fabric, said biodegradable nonwoven replacement materials could fulfil the international biodegradation standard EN13432.

In one aspect of the biodegradable nonwoven replacement materials of the present invention, wherein the biodegradable spunbond fabric has an average diameter in the range of between 1 and 50 microns and the surface density is in the range of between 10 and 200 gsm.

In another aspect of the biodegradable nonwoven replacement materials of the present invention, wherein the specific biodegradable spunbond fabric comprises first biodegradable polymers and functional additives.

In one aspect of the biodegradable nonwoven replacement materials of the present invention, wherein the first biodegradable polymers include, polylactic acid, polycaprolactone, polyhydroxyalkanoates, polybutylene adipate terephthalate and etc.

In another aspect of the biodegradable nonwoven replacement materials of the present invention, wherein the functional additive includes nucleating agent, plasticizer, stabilizer, waterproof and anti-oxidant.

In one aspect of the biodegradable nonwoven replacement materials of the present invention, wherein the functional additives are processed to spunbond resin with first biodegradable polymers by twin screw extrusion, with the extrusion temperature ranged from 170° C. to 200° C., temperature of roller range from 45° C. to 70° C., frequency of collector ranged from 10 Hz to 50 Hz.

In another aspect of the biodegradable nonwoven replacement materials of the present invention, wherein the spunbond resin is processed to spunbond fabrics by spunbonding technology.

In one aspect of the biodegradable nonwoven replacement materials of the present invention, wherein the nanofiber membrane having an average diameter in the range of between 50 and 1000 nm, thickness in the range of between 2 and 50 μm and water contact angle in the range of 110° and 170°.

In another aspect of the biodegradable nonwoven replacement materials of the present invention, wherein the nanofiber membrane comprises second biodegradable polymers and biodegradable hydrophobic additives. Both nanofiber membrane and spunbond fabric comprises of biodegradable polymers, said first and second biodegradable polymers can be of the same type but can also be different.

In one aspect of the biodegradable nonwoven replacement materials of the present invention, wherein the second biodegradable polymers refers to the modified biodegradable polymer by melting blending.

In another aspect of the biodegradable nonwoven replacement materials of the present invention, wherein the melting blending is achieved by twin screw extrusion of second biodegradable polymer and plasticizer.

In one aspect of the biodegradable nonwoven replacement materials of the present invention, wherein the second biodegradable polymers include, polylactic acid, polycaprolactone, polyhydroxyalkanoates, polybutylene adipate terephthalate and etc.

In another aspect of the biodegradable nonwoven replacement materials of the present invention, wherein the plasticizer includes epoxidized soybean oil, succinic anhydride, benzoic acid anhydride, and etc, and said plasticizer ranged from 0.01% to 5%.

In one aspect of the biodegradable nonwoven replacement materials of the present invention, wherein the concentration of second biodegradable polymers is 10%-25%.

In another aspect of the biodegradable nonwoven replacement materials of the present invention, wherein the molecular weight range of the second biodegradable polymers is 50,000-300,000 g/mol.

In one aspect of the biodegradable nonwoven replacement materials of the present invention, wherein the biodegradable hydrophobic additives are natural-based hydrophobic additives, include Carnauba wax, insect wax, linseed oil and tung oil and etc, and the particle size of said natural-based hydrophobic additives is ranged from 50 μm to 500 μm.

In another aspect of the biodegradable nonwoven replacement materials of the present invention, wherein the concentration of biodegradable hydrophobic additives is 5%-15%.

In one aspect of the biodegradable nonwoven replacement materials of the present invention, wherein the nanofiber membrane is prepared by needle spinneret, multiple spinneret or wire spinneret electrospinning system, with the electrospinning conditions voltage at the range of 30-70 kV; spinneret feeding rate at the range of 1-200 ml/hour; tip-to-collector distance at the range of 100 mm-300 mm; substrate speed at the range of 60-100 mm/min; temperature at the range of 25-40° C.; relative humidity at the range of 20-50%.

The fiber characteristic of the biodegradable nonwoven replacement materials of the present invention is tailored to fulfill the specification of Personal Protective Equipment (“PPE”) and surgical mask. The biodegradable nonwoven replacement materials comprising a non-woven fabric for the PPE, and a non-woven fabric for surgical mask, such as a three layer surgical mask. Said non-woven fabric for the PPE and said non-woven fabric for the surgical mask are different. Said non-woven fabric for the PPE has at least 45N breaking force, at least 15% elongation, and having passed level 3 fluid resistance test according to AATCC 42 and AATCC 127. Said three layer surgical mask has no more than 5 mmH2O/cm2 differential pressure (8 LPM over 4.9 cm2), at least 95% filtration efficiency for 0.1 μm particles under 28.3 LPM flow rate and having passed the fluid resistance test according to ASTM F2100 level 1.

### BRIEF DESCRIPTION OF THE DRAWINGS

In order to more clearly illustrate the technical solutions in the embodiments of the present invention, the following will brief the drawings that need to be used in the embodiments. Obviously, the drawings in the following description are only some examples of the present invention. For those of ordinary skill in the art, other drawings may be obtained based on these drawings without creative efforts.

FIG. 1A shows the water contact angle change of PLA nanofiber membrane of Embodiment 4 of the present invention.

FIG. 1B shows the water contact angle change of PLA nanofiber membrane of Embodiment 4 of the present invention after a period of time.

FIG. 2A shows the water contact angle change of PLA nanofiber membrane of Embodiment 5 of the present invention.

FIG. 2B shows the water contact angle change of PLA nanofiber membrane of Embodiment 5 of the present invention after the same period of time as Embodiment 4.

FIG. 3A shows the water contact angle change of PLA nanofiber membrane of Embodiment 6 of the present invention.

FIG. 3B shows the water contact angle change of PLA nanofiber membrane of Embodiment 6 of the present invention after the same period of time as Embodiment 4.

FIG. 4 is the SEM image of PLA nanofiber membrane of Embodiment 4 of the present invention.

FIG. 5 is the SEM image of PLA nanofiber membrane of Embodiment 7 of the present invention.

FIG. 6 shows water contact angle image of spunbond nonwoven fabrics prepared by Comparative example 2.

FIG. 7 shows water contact angle image of spunbond nonwoven fabrics prepared by Embodiment 10.

FIG. 8 shows the procedure of making the PLA pellets of the present invention.

FIG. 9 shows the spunbond procedure of nonwoven fabrics of the present invention.

FIG. 10 shows the extrusion procedure for the PLA pellets of the present invention.

FIG. 11 depicts a substrate roll of spunbond material.

FIG. 12 schematically depicts an electrospinning process

FIG. 13 schematically depicts a multilayer electrospun and spunbond composite material.

### DETAILED DESCRIPTION

In one aspect, the present invention provides a polylactic-acid-based material that is both biodegradable and hydrophobic. A material is generally considered hydrophobic when its water contact angle is greater than 90°. In contrast, hydrophilic materials have a water contact angle below 90°. The higher the contact angle, the more hydrophobic the surface is. Superhydrophobic materials have contact angles greater than 150°, causing water to bead up and roll off the surface.

For personal protective equipment (PPE) like face masks, hydrophobicity is important to repel water-based aerosols and droplets that may carry pathogens. Ideally, the outer layer of a face mask should have a high water contact angle to ensure that water droplets do not penetrate the mask material. However, balancing hydrophobicity and breathability is crucial; the material should be hydrophobic enough to repel fluids but still allow air to pass for comfort and efficacy.

For face masks, the outer layer should ideally be hydrophobic (angle>90°) but not so extreme as to make the mask uncomfortable or reduce its filtering performance. Although polylactic acid (PLA) has many desirable qualities, such as biodegradability and ease of processing, its hydrophobicity is relatively low compared to more conventional personal protective material (PPE) materials like polypropylene.

The water contact angle for unmodified PLA and other biodegradable polymers such as polycaprolactone, polyhydroxyalkanoates, polybutylene adipate terephthalate is typically in the range of 65° to 80°, depending on the processing and surface conditions. This means PLA is mildly hydrophilic, and it is less effective at repelling water than more hydrophobic materials like polypropylene. Therefore, in its untreated form, PLA is not sufficiently hydrophobic for use as a biodegradable PPE material. Further, as described above, it is difficult to use biodegradable additives with various fabrication techniques and still achieve and acceptable level of filtration.

To make PLA fabrics more suitable for PPE applications, the present invention provides biodegradable hydrophobic additives to PLA to increase the water contact angle to at least approximately 110°. By increasing the water contact angle to at least approximately 110 degrees, the fabric repels liquids, particularly bodily fluids such as blood and saliva. The PLA biodegradable polymer may be used on its own or mixed with other biodegradable polymers such as polycaprolactone (PCL), polyhydroxyalkanoates (PHA), or polybutylene adipate terephthalate (PBAT). The molecular weight range of the biodegradable polymers is 50,000-300,000 g/mol.

In addition to hydrophobic additives, biodegradable plasticizers may also be added to increase the processing capability of the PLA, permitting it to be formed into fibers of suitable sizes for personal protective equipment. The size of the PLA fibers may be different for different layers of material in the PPE in order to optimally balance filtration efficiency and breathability. Other optional additives include nucleating agents, stabilizers, and anti-oxidants.

Examples of hydrophobic additives include natural waxes and oils including Carnauba wax, insect wax, linseed oil and tung oil. The particle size the hydrophobic additives ranges from 50 μm to 500 μm in an amount of approximately 5%-15%. Examples of plasticizers include epoxidized soybean oil, succinic anhydride, benzoic acid anhydride in an amount from from approximately 0.01% to 5%.

Optionally, the hydrophobic additives and plasticizers are added to the biodegradable polymer and are mixed together in an extrusion process. The extruded pellets, having been thoroughly mixed with the additives and plasticizers, may be formed into modified, hydrophobic, biodegradable polymer pellets. These pellets may then be used as starting materials for nanofiber electrospinning as the pellets exhibit better solubility in organic solvents for creating electrospinning solutions. Additionally, the pellets may be used as starting materials in spunbonding processes.

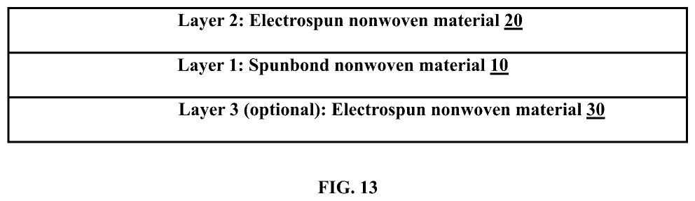

As seen in FIG. 13, in one aspect, the formed biodegradable materials of the present invention may include a first layer 10 of a spunbond nonwoven material having a layer 20 of nanofiber material bound to the layer 10 of spunbond nonwoven material. No extra binder is used between layers 10 and 20. Optionally, a second nanofiber material layer 30 may be bonded to layer 10 of spunbond nonwoven material on a side opposite to layer 20. In the embodiment of FIG. 13, the nanofiber material has an average diameter in the range of between 50 and 1000 nm and a thickness in the range of between 2 and 50 μm and water contact angle in the range of 110° and 170°.

Spunbond layer 10 is a nonwoven layer formed spinbonding. During spinbonding, the biodegradable polymer is melted and extruded through fine nozzles to create continuous filaments having a diameter of 1 to 50 microns. The filaments are spread over a conveyor belt to form a loose web of fibers. The drawing is done by air (high-velocity airflow) or mechanical means, which helps to align and stretch the fibers. The nonwoven web of fibers is then bonded, usually by thermal, chemical, and/or mechanical means (e.g., heat and pressure), to create a coherent nonwoven spunbond fabric. The surface density of the formed spunbond nonwoven material is in the range of between 10 and 200 gsm.

The nanofiber layer may be prepared by needle spinneret, as schematically depicted in FIG. 12, multiple spinneret or wire spinneret electrospinning system. Because PLA and other biodegradable polymers have lower elasticity compared to some synthetic polymers like polypropylene, the plasticizer additives and optional polymer blends of the present invention assist in the electrospinning process by making the polymer filaments more pliable and less prone to breakage.

A high-voltage electric charge is applied to the polymer solution, causing it to elongate and form thin fibers. A spunbond nonwoven material layer may be placed on the grounded collection platform in order to directly receive the nanofibers. Typical electrospinning conditions include: voltage at the range of 30-70 kV; spinneret feeding rate at the range of 1-200 ml/hour; tip-to-collector distance at the range of 100 mm-300 mm; substrate speed at the range of 60-100 mm/min; temperature at the range of 25-40° C.; relative humidity at the range of 20-50%.

The nonwoven fabrics formed according to the compositions and methods of the present invention have at least 45N breaking force, at least 15% elongation, and pass level 3 fluid resistance test according to AATCC 42 and AATCC 127. A three-layer fabric of spunbond and electrospun fabric has no more than 5 mmH₂O/cm² differential pressure (8 LPM over 4.9 cm2), at least 95% filtration efficiency for 0.1 μm particles under 28.3 LPM flow rate and having passed the fluid resistance test according to ASTM F2100 level 1. Further, the biodegradable nonwoven composite conform to international biodegradation standard EN13432.

Said biodegradable spunbond fabric is made by pellets extrusion at first and then spunbond. In one example, the method of producing the layer of biodegradable spunbond fabric comprises the following steps: mixing the biodegradable polymer (biodegradable resin), for example, but not limited to, polylactic acid (PLA), polycaprolactone (PCL), polyhydroxyalkanoates (PHA), polybutylene adipate terephthalate (PBAT)), and feeding the mixture to twin screw extruder to make pellets; and feeding the prepared pellets to spunbond machine, and collecting the biodegradable fibers to make fabrics. The above functional additives are processed with biodegradable polymers to produce spunbond resin by twin screw extrusion, with the extrusion temperature ranged from 170° C. to 200° C., temperature of roller range from 45° C. to 70° C., frequency of collector ranged from 10 Hz to 50 Hz. The spunbond resin is processed to spunbond fabrics by spunbonding technology.

Biodegradable hydrophobic additives are added to improve the hydrophobicity of biodegradable nonwoven fabrics. The biodegradable nonwoven fabrics are prepared by spunbond and solution electrospinning. No surfactant is added for solution electrospinning. The electrospinning solution is prepared by modified biodegradable with improved solubility. The solution electrospinning solution is prepared at room temperature. For solution electrospinning, the solution can be electrospun by needle spinneret, multiple spinneret or commercial wire spinneret electrospinning system.

### EXAMPLES

The present invention provides the following Examples 1-5, which respectively show experimental results of different biodegradable pellets with respect to electrospinning. The fluid resistance performance of nanofiber layers with different concentrations of natural waxes is demonstrated, along with properties of according to different diameters and filtration performance of PLA nanofibers, different thickness and filtration performances, and different hydrophobicity of spunbond nonwoven fabrics.

Example 1 comprises comparative example 1, and embodiments 1, 2 and 3 which compare the electrospinnability of biodegradable pellets of the present invention. In comparative example 1, the commercially-obtained PLA resin was not dried or mixed with ESO. The PLA pellets refer to modified PLA pellets which are mixed with additives according to the present invention. The electrospinnability of the biodegradable pellets were evaluated in terms of electrospinning needle clogging and fiber formation.

### Comparative Example 1

1.5 g PLA resin with 1.4% D-lactide content were added to mixture of Dichloromethane (“DCM”) and Dimethylformamide (“DMF”), the ratio of DCM and DMF was 1:1 by volume. The blend was stirred at room temperature until PLA resin was dissolved. Then the blend was injected to electrospinning equipment with the operation condition: Voltage: 30 kV; Feed rate: 1 ml/h; Tip-to-collector distance: 210 mm.

### Embodiment 1

Before mixing, the PLA resin were dried at 70° C. for 3 hours. 380 g PLA resin with 1.4% D-lactide content were mixed with 20 g epoxidized soybean oil (“ESO”) and fed to twin screw extruder. The extrusion temperature was 170° C.-180° C. Then 1.8 g extruded pellets were added to mixture of DCM and DMF, the ratio of DCM and DMF was 1:1 by volume. The blend was stirred at room temperature until PLA resin was dissolved. Then the blend was injected to electrospinning equipment with the operation condition: Voltage: 30 kV; Feed rate: 1 ml/h; Tip-to-collector distance: 210 mm.

### Embodiment 2

Before mixing, the PLA resin were dried at 70° C. for 3 hours. 380 g PLA resin with 12% D-lactide content were mixed with 20 g ESO and fed to twin screw extruder. The extrusion temperature was 170° C.-180° C. Then 1.8 g extruded pellets were added to mixture of DCM and DMF, the ratio of DCM and DMF was 1:1 by volume. The blend was stirred at room temperature until PLA resin was dissolved. Then the blend was injected to electrospinning equipment with the operation condition: Voltage: 30 kV; Feed rate: 1 ml/h; Tip-to-collector distance: 210 mm.

### Embodiment 3

Before mixing, the PLA resin were dried at 70° C. for 3 hours. 395 g PLA resin with 12% D-lactide content were mixed with 5 g ESO and fed to twin screw extruder. The extrusion temperature was 170° C.-180° C. Then 1.5 g extruded pellets were added to mixture of DCM and DMF, the ratio of DMF and acetone was 1:1 by volume. The blend was stirred at room temperature until PLA resin was dissolved. Then the blend was injected to electrospinning equipment with the operation condition: Voltage: 30 kV; Feed rate: 1 ml/h; Tip-to-collector distance: 210 mm.

Table 1 shows the evaluation results of the electrospinnability of PLA pellets prepared under Comparative Example 1, Embodiments 1, 2 and 3. According to table 1, electrospinnability of PLA pellets prepared by embodiment 1, embodiment 2 and embodiment 3 were improved compared with comparative example 1.

TABLE 1
Evaluation Results of the electrospinnability of PLA pellets

| | Electrospinning performance | |
|---|---|---|
| | Needle clogging during | |
| Experiments | electrospinning | Fiber formation |
| Comparative example 1 | Yes | No |
| Embodiment 1 | Yes | Yes |
| Embodiment 2 | yes | Yes |
| Embodiment 3 | No | yes |

Example 2 comprises Embodiments 4, 5 and 6 and compares fluid resistance performance of PLA nanofiber membrane with different concentration of nature wax. The fluid resistance performance was measured by change of water contact angle over time.

### Embodiment 4

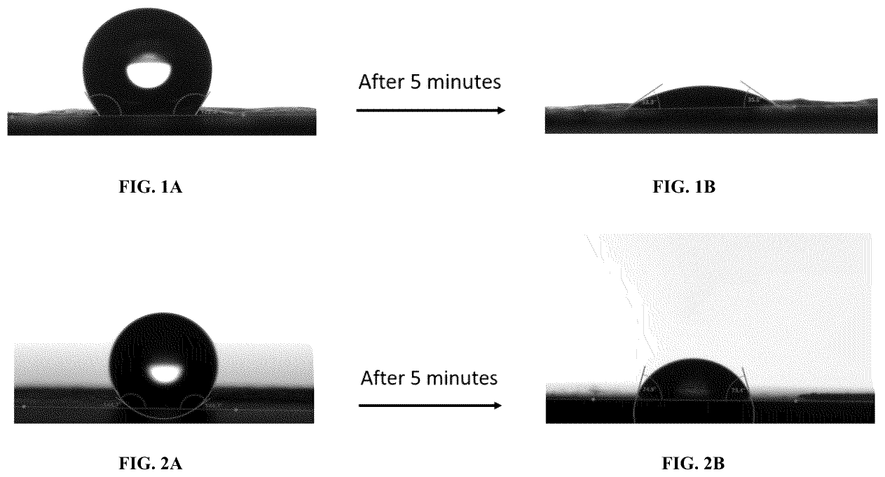

1.8 g prepared PLA pellets was dissolved in 10 ml mixed solvents of DMF and acetone, the ratio of DMF and acetone was 1:1 by volume. The blend was stirred at room temperature until a clear homogeneous solution was observed. The PLA solution was injected to the electrospinning equipment and electrospun under the following condition: Voltage: 45 kV; tip-to-collector distance: 210 mm; feed rate: 16 ml/h, substrate speed: 80 mm/min. Then the PLA nanofiber membrane was obtained. FIG. 1 shown the water contact angle change of PLA nanofiber membrane (without nature wax) prepared by embodiment 4.

### Embodiment 5

0.3 g nature wax was added to 5 ml acetone and stirred at temperature for overnight. Then 1.8 g prepared PLA pellets and 5 ml DMF were added to the mixture and stirred until PLA pellets was completely dissolved. The PLA/nature wax solution was injected to electrospinning equipment and electrospun under the following condition: Voltage: 45 kV; tip-to-collector distance: 210 mm; feed rate: 16 ml/h, substrate speed: 80 mm/min. Then the PLA/nature wax nanofiber membrane was obtained. FIG. 2 shown the water contact angle change of PLA nanofiber membrane (with 3% nature wax) prepared by embodiment 5.

### Embodiment 6

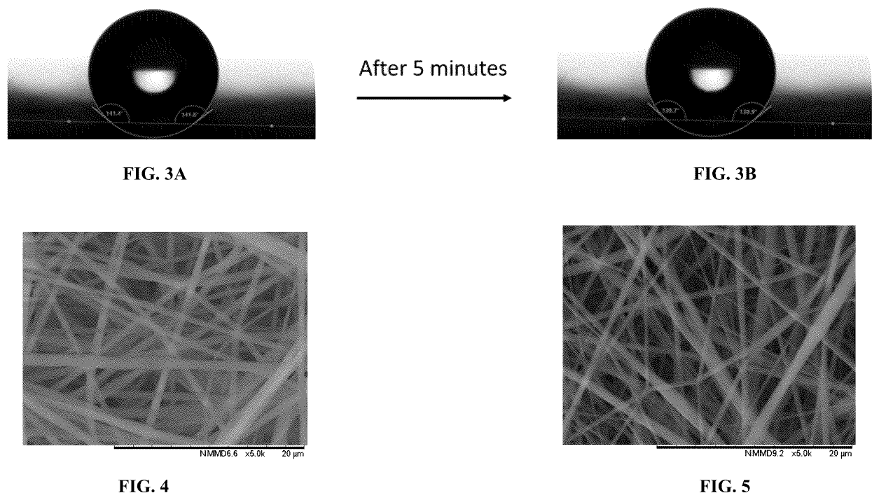

0.6 g nature wax was added to 5 ml acetone and stirred at temperature for overnight. Then 1.8 g prepared PLA pellets and 5 ml DMF were added to the mixture and stirred until PLA pellets was completely dissolved. The PLA/nature wax solution was injected to electrospinning equipment and electrospun under the following condition: Voltage: 45 kV; tip-to-collector distance: 210 mm; feed rate: 16 ml/h, substrate speed: 80 mm/min. Then the PLA/nature wax nanofiber membrane was obtained. FIGS. 3A-3B shown the water contact angle change of PLA nanofiber membrane (with 6% nature wax) prepared by embodiment 6.

According to the water contact angle results, the change in initial and water contact angle after a few minutes, for example 5 minutes over time, was smaller when more nature wax was added. The fluid resistance performance of PLA nanofiber membrane could be improved with the increase of nature wax content.

Example 3 comprises Embodiments 4 and 7 and compares the diameter and filtration performance of PLA nanofiber membrane prepared by Embodiments 4 and 7.

### Embodiment 7

1.8 g prepared PLA pellets was dissolved in 10 ml mixed solvents of DMF and acetone, the ratio of DMF and acetone was 1:1 by volume. The blend was stirred at room temperature until a clear homogeneous solution was observed. The PLA solution was injected to the electrospinning equipment and electrospun under the following condition: Voltage: 50 kV; tip-to-collector distance: 270 mm; feed rate: 8 ml/h, substrate speed at the range of 60-100 mm/min. Then the PLA nanofiber membrane was obtained.

For nanofiber membrane prepared by embodiment 4, the average diameter was about 450 nm. And the filtration efficiency of 0.1 μm was 99.1% with 3.1 mmH2O/cm2 differential pressure. For nanofiber membrane prepared by embodiment 7, the average diameter was about 219 nm. And the filtration efficiency of 0.1 μm was 99.99% with >5 mmH2O/cm2 differential pressure. The diameter of Nanofiber could be tuned by electrospinning parameter, e.g., voltage, feed rate and tip-to-collector distance, hence, the filtration performance could be controlled. Table 2 showed filtration performance of these two tested nanofiber membranes. FIG. 4 is the SEM image of PLA nanofiber membrane of one embodiment of the present invention, embodiment 4. FIG. 5 is the SEM image of PLA nanofiber membrane of another embodiment of the present invention, embodiment 7.

TABLE 2
Filtration Performance of tested nanofiber membranes

| | Diameter | Differential pressure | Filtration |
|---|---|---|---|
| Experiments | (nm) | (mmH₂O/cm²) | efficiency (%) |
| embodiment 4 | 450 | 3.1 | 99.1 |
| embodiment 7 | 219 | >4 | 99.99 |

Example 4 comprises Embodiments 4, 8 and 9 and compares the thickness and filtration performance of PLA nanofiber prepared by embodiment 4, embodiment 8 and embodiment 9.

### Embodiment 8

1.8 g prepared PLA pellets was dissolved in 10 ml mixed solvents of DMF and acetone, the ratio of DMF and acetone was 1:1 by volume. The blend was stirred at room temperature until a clear homogeneous solution was observed. The PLA solution was injected to the electrospinning equipment and electrospun under the following condition: Voltage: 45 kV; tip-to-collector distance: 210 mm; feed rate: 16 ml/h, substrate speed: 70 mm/min. Then the PLA nanofiber membrane was obtained.

### Embodiment 9

1.8 g prepared PLA pellets was dissolved in 10 ml mixed solvents of DMF and acetone, the ratio of DMF and acetone was 1:1 by volume. The blend was stirred at room temperature until a clear homogeneous solution was observed. The PLA solution was injected to the electrospinning equipment and electrospun under the following condition: Voltage: 45 kV; tip-to-collector distance: 210 mm; feed rate: 16 ml/h, substrate speed: 60 mm/min. Then the PLA nanofiber membrane was obtained.

The average diameter of the three tested PLA nanofiber membranes in Embodiments 4, 8 and 9 was 450 nm. The thickness of the tested PLA nanofiber membranes in Embodiments 4, 8 and 9 was respectively 18 μm, 22 μm and 29 μm. Table 3 showed filtration performance of these three tested nanofiber membranes.

TABLE 3
Filtration Performance of three tested nanofiber membranes

Filtration performance

| | | Differential | Filtration |
|---|---|---|---|
| | Thickness | pressure | efficiency |
| Experiments | (μm) | (mmH₂O/cm²) | (%) |
| embodiment 9 | 29 | 4.4 | 99.6 |
| embodiment 8 | 22 | 3.6 | 99.5 |
| embodiment 4 | 18 | 3.1 | 99.1 |

According to the test results in Table 3, the filtration efficiency of tested samples were all above 99%. And the differential pressure was reduced with decrease of thickness. Hence, filtration performance could be adjusted by tuning thickness of nanofiber membrane.

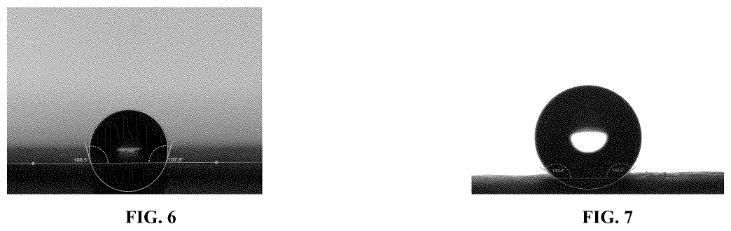

Example 5 comprises Comparative example 2 and Embodiment 10 and compares the hydrophobicity of spunbond nonwoven fabrics prepared by Comparative example 2 and embodiment 10. The hydrophobicity of spunbond nonwoven fabrics was evaluated by water contact angle. FIG. 6 shows water contact angle image of spunbond nonwoven fabrics prepared by Comparative example 2. FIG. 7 shows water contact angle image of spunbond nonwoven fabrics prepared by Embodiment 10. According to these two FIGs, water contact angle of sample prepared by embodiment 10 was higher, indicating a better hydrophobic behavior.

### Comparative Example 2

The spunbond fabrics was obtained by spunbonding of PLA pellets. The PLA pellets were fed to spunbond machine with 180° C.-230° C. spinning temperature and 70° C. bonding temperature.

### Embodiment 10

The spunbond fabrics was obtained by twin screw extrusion for pellets making and spunbind for fabric fabrication. Firstly, 958 g PLA was mixed with 2 g Epoxidized soybean oil (“ESBO”), 10 g silane-modified CaCO3, 7 g additives, such as Millad® 3988, and 5 g Antioxidants, such as Irganox®. The mixture was injected to twin screw extruder with 170° C.-180° C. operation temperature to make pellets. Then the pellets were fed to spunbond machine with 180° C.-230° C. spinning temperature and 70° C. bonding temperature.

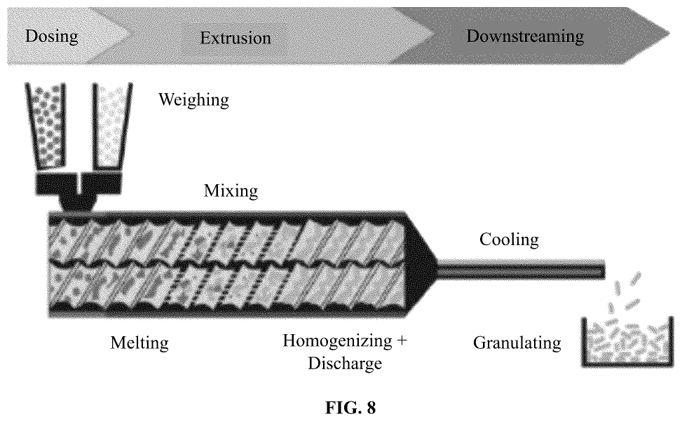

FIG. 8 shows the producing procedure of the nanofiber membrane of the present invention. The method of producing the nanofiber membrane is produced by producing the PLA pellets, which comprises the following steps: dosing the PLA resin with D-lactide content to mix with plasticizer, said plasticizer including but not limiting to epoxidized soybean oil, succinic anhydride, benzoic acid anhydride, and etc.; feeding said mixture to twin screw extruder, through melting and homogenizing procedures, the method of producing the PLA pellets reaches the stage of down streaming, after cooling and granulating, the PLA pellets are produced.

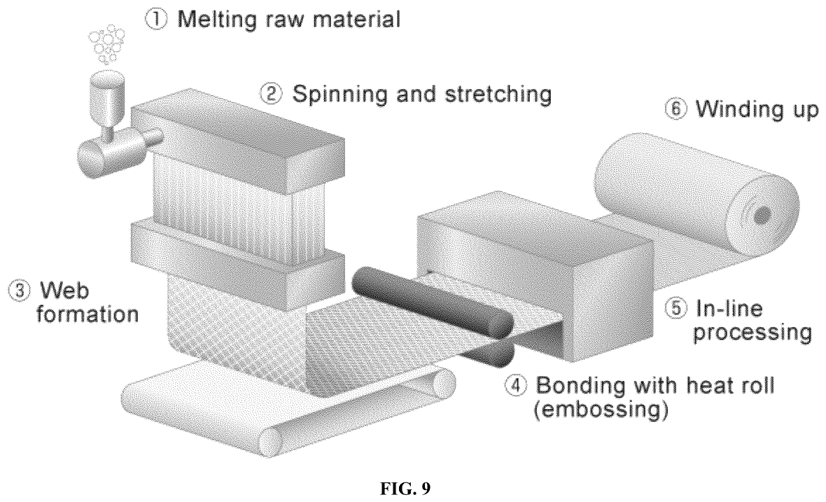

FIG. 9 shows the spunbond procedure of nonwoven fabrics of the present invention. The spunbond procedure comprises the following steps: melting raw materials; spinning and stretching the melted raw materials; forming web; bonding or embossing said web with double heat rolls; processing the bonded web to in-line processing before finally winding it up.

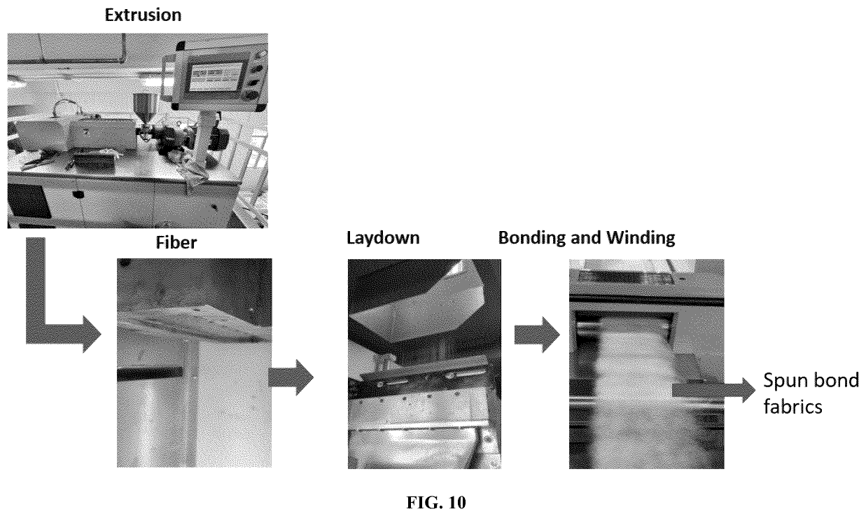

FIG. 10 shows the producing procedure of the present invention. The PLA pellets are obtained through extrusion, and said extruded PLA pellets are added to mixture of the organic solvents, such as DCM and DMF; said blend is stirred at room temperature until the PLA pellets are disclosed; and said blend is injected to electrospinning equipment to produce the fiber; and laydown said fiber and bonding and winding the same to produce spunbond fabrics of the present invention.

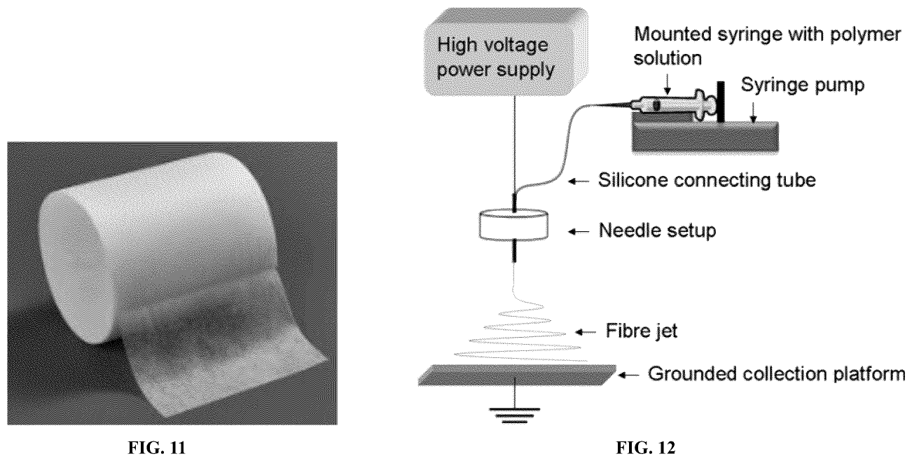

FIG. 11 shows a substrate roll of spunbond material of the present invention.

FIG. 12 shows the procedure of electrospinning of the present invention. During the electrospinning procedure, an electrospinning machine is adopted. the PLA solution is injected to said electrospinning machine, under particular electrospinning conditions, such as with the high voltage power supply at the range of 30-70 kV; spinneret feeding rate at the range of 1-200 ml/hour; tip-to-collector distance at the range of 100 mm-300 mm; substrate speed at the range of 60-100 mm/min; temperature at the range of 25-40° C.; relative humidity at the range of 20-50%; syringe with the PLA solution is mounted; through a syringe pump, said PLA solution is injected to a platform with set needle and high voltage power supply through a silicone connecting tube; after fibre jet, the PLA nanofiber is obtained at the grounded collection platform.

The present invention provides a method for producing a biodegradable and hydrophobic polylactic acid (PLA) non-woven material through the following steps:
blending the biodegradable PLA polymer to modify characteristics thereof in the organic solvents;
selecting the polymer-solvent matrix to achieve a spinnable viscosity;
separating the concentrated polymer chain apart by electric force during electrospinning, including high voltage difference;
increasing the conductivity of polymer solution for easy separation of concentrated polymer chain.

By the above approaches, the biodegradable PLA nanofiber can be fabricated with diameter around 150 nm which is much finer than the existing biodegradable PLA nanofiber. With such fiber characteristics, the filtration performance with breathability can be achieved for ASTM F2100 Level 1 surgical mask and PPE and achieve the fluid resistance requirement.

Hydrophobic additives are added to improve the hydrophobicity of biodegradable nonwoven fabrics. No need to use two kinds of polymer, the polymer is modified by melting blending. The nonwoven fabrics are produced by spunbond method and electrospinning method. The nonwoven fabrics consist of two kinds of fabrics with different diameter range. The fiber diameter of spunbond fabrics is 1-50 μm, the fiber diameter of nanofiber fabrics is 50-1000 nm.

The terms “one embodiment”, “an embodiment” or “one or more embodiments” referred to herein means that a specific feature, structure, or characteristic described in combination with the embodiment is included in at least one embodiment of the present invention. In addition, it should be noted that the word examples “in one embodiment” herein do not necessarily all refer to the same embodiment.

The above description is not intended to limit the meaning or scope of the words used in the following claims that define the present invention. Rather, the description and illustration are provided to help understand the various embodiments. It is expected that future changes in structure, function, or results will exist without substantial changes, and all these insubstantial changes in the claims are intended to be covered by the claims. Therefore, although the preferred embodiments of the present invention have been illustrated and described, those skilled in the art will understand that many changes and modifications may be made without departing from the claimed invention. In addition, although the term “claimed invention” or “present invention” is sometimes used herein in the singular form, it will be understood that there are multiple inventions as described and claimed.

1. A hydrophobic biodegradable nonwoven fabric comprising:
a nonwoven spunbond layer having spunbond fiber sizes ranging from approximately 1 micron to approximately 50 microns;
a nonwoven electrospun layer formed on the nonwoven spunbond layer having electrospun fiber sizes ranging from approximately 10 nanometers to approximately 1000 nanometers;
wherein electrospun fibers include at least a first biodegradable polymer selected from polylactic acid, polycaprolactone, polyhydroxyalkanoates, or polybutylene adipate terephthalate, one or more plasticizers, and one or more hydrophobic additives;
the hydrophobic biodegradable nonwoven fabric having a water contact angle of at least 110° and having at least 45N breaking force, at least 15% elongation, and conforming to level 3 fluid resistance test according to AATCC 42 and AATCC 127.

2. The hydrophobic biodegradable nonwoven fabric of claim 1, wherein the surface density in the range of between 10 and 200 gsm.

3. The hydrophobic biodegradable nonwoven fabric of claim 1, wherein the hydrophobic additives are one or more of Carnauba wax, insect wax, linseed oil or tung oil.

4. The hydrophobic biodegradable nonwoven fabric of claim 3, wherein the hydrophobic additive has a particle size of 50 μm to 500 μm.

5. The hydrophobic biodegradable nonwoven fabric of claim 1, wherein the electrospun fibers include a second biodegradable polymer selected from polylactic acid, polycaprolactone, polyhydroxyalkanoates, or polybutylene adipate terephthalate having a molecular weight of 50,000-300,000 g/mol in an amount of 10% to 25%.

6. The hydrophobic biodegradable nonwoven fabric of claim 1, wherein the spunbond fibers include at least one biodegradable polymer selected from polylactic acid, polycaprolactone, polyhydroxyalkanoates, or polybutylene adipate terephthalate.

7. The hydrophobic biodegradable nonwoven fabric of claim 1, wherein the hydrophobic biodegradable nonwoven fabric meets the biodegradation standard of EN13432.

8. The hydrophobic biodegradable nonwoven fabric of claim 1, wherein the plasticizer is present in an amount from approximately 0.01% to approximately 5%.

9. The hydrophobic biodegradable nonwoven fabric of claim 1, wherein the hydrophobic additive is present in an amount from approximately 5%-15%.

10. The hydrophobic biodegradable nonwoven fabric of claim 1, further comprising a third nonwoven layer and wherein the fabric has not more than 5 mmH₂O/cm² differential pressure (8 LPM over 4.9 cm²), at least 95% filtration efficiency for 0.1 μm particles under 28.3 LPM flow rate, and conforms to a fluid resistance test according to ASTM F2100 level 1.

11. A method for fabricating the hydrophobic biodegradable nonwoven fabric of claim 1, comprising:
forming modified hydrophobic biodegradable polymer pellets by mixing at least a first biodegradable polymer selected from polylactic acid, polycaprolactone, polyhydroxyalkanoates, or polybutylene adipate terephthalate, one or more plasticizers, and one or more hydrophobic additives, and extruding the mixture to form the modified hydrophobic biodegradable polymer pellets;
dissolving the modified hydrophobic biodegradable polymer pellets in a solvent;
electrospinning the dissolved modified hydrophobic biodegradable polymer to form a nonwoven electrospun layer on a spunbond layer.

12. The method of claim 11, wherein forming the modified hydrophobic biodegradable polymer pellets comprises adding the plasticizer and hydrophobic additive to a twin screw extruder at an extrusion temperature ranging from 170° C. to 200° C.

13. The method of claim 11, wherein the electrospinning is performed at by needle spinneret, multiple spinneret or wire spinneret electrospinning system, with electrospinning voltage in a range from 30-70 kV; spinneret feeding rate in a range of 1-200 ml/hour; tip-to-collector distance in a range from 100 mm-300 mm; substrate speed at the range of 60-100 mm/min; temperature in a range of 25-40° C.; relative humidity at the range of 20-50%, temperature of roller range from 45° C. to 70° C., frequency of collector ranged from 10 Hz to 50 Hz.
